(19) United States
(12) Patent Application Publication
(10) Pub. No.: US 2022/0082686 A1
(43) Pub. Date: Mar. 17, 2022

(54) SATELLITE CONSTELLATION SYSTEMS AND METHODS FOR COMBINED AVIATION AND WEATHER SURVEILLANCE

(71) Applicant: Nexteon Technologies, Inc., Maple Glen, PA (US)

(72) Inventors: Cornelius George Hunter, Cameron Park, CA (US); Robert Kaimowitz, Maple Glen, PA (US)

(21) Appl. No.: 17/471,555

(22) Filed: Sep. 10, 2021

Related U.S. Application Data
(60) Provisional application No. 63/076,973, filed on Sep. 11, 2020.

(51) Int. Cl. G01S 13/95; G08G 5/00; G01S 13/00; G01S 19/02

(52) U.S. Cl. CPC G01S 13/955; G08G 5/0004; H01Q 1/288; G01S 13/003; G01S 19/02; G08G 5/0091

(57) ABSTRACT

A global airspace surveillance system is disclosed that includes a plurality of satellites that receive weather information from GNSS satellites, and that derive air traffic information from air traffic via satellite antennas directed toward earth's horizon.

### PRIORITY

The present application claims priority to U.S. Provisional Patent Application No. 63/076,973 filed Sep. 11, 2020, the disclosure of which is hereby incorporated by reference in its entirety.

### BACKGROUND

The invention generally relates to environmental data collection systems, and relates in particular to airspace data collection systems.

In large-scale commercial airspace systems, such as the National Airspace System (NAS) in the United States and other analogous systems around the world, the two primary surveillance targets are traffic and weather. These two types of targets are sometimes referred to as “hard targets” and “soft targets,” respectively, in reference to their physical structures. Not surprisingly they have traditionally required entirely different surveillance technologies and systems. The requirement for dual, independent surveillance systems in the same airspace volume has led to higher procurement and maintenance costs and has inspired researchers to investigate unified approaches.

If the traffic and weather surveillance requirements could be integrated into a single system, then the cost savings could be significant. For example, this unified approach was the objective of the Multi-Purpose Airport Radar (MPAR) and Terminal Area Surveillance System (TASS) programs from thirty years ago. More recently the Spectrum Efficient National Surveillance Radar (SENSR) program seeks to solve this problem, while also freeing up much needed radio frequency (RF) spectrum space. A limitation of all these approaches is that they are ground-based, and so do not provide oceanic, remote region, or otherwise global surveillance products. This is a significant limitation for several reasons, including for example, coverage and possibly accuracy.

There remains a need, therefore, for more effective yet efficient and economical airspace surveillance systems.

### SUMMARY

In accordance with an aspect, the invention provides a global airspace surveillance system that includes a plurality of satellites that derive weather information from GNSS satellites, and that receive air traffic information from air traffic via satellite antennas directed toward earth's horizon.

In accordance with another aspect, the invention provides a method of providing a global airspace surveillance system. The method includes providing a plurality of satellites, deriving weather information from GNSS satellites, and receiving air traffic information from air traffic via satellite antennas directed toward earth's horizon.

In accordance with a further aspect, the invention provides a global airspace surveillance system that includes a plurality of satellites that each include at least one antenna that is directed along a beam direction of earth's horizon at an angle of no more than about 60 degrees from horizontal at each respective satellite.

### BRIEF DESCRIPTION OF THE DRAWINGS

The following description may be further understood with reference to the accompanying drawings in which:

FIG. 1 shows an illustrative diagrammatic view of a GAUSS satellite making an RO sounding using a navigational system from a Glonass satellite and receiving ADS-B signals from aircraft in a system in accordance with an aspect of the present invention;

FIG. 2 shows an illustrative diagrammatic view of a low earth orbit constellation for use in a system in accordance with an aspect of the present invention;

FIG. 3 shows an illustrative graphical representation of approximate horizontal elevation angle as a function of orbital altitude in accordance with an aspect of the present invention;

FIG. 4 shows an illustrative diagrammatic view of two antenna beams, having the identical beamwidth (i.e., identical angle), from a satellite, one directed downward and one directed toward the horizon in accordance with an aspect of the present invention;

FIG. 5 shows an illustrative graphical representation of elevation angle and associated area for antenna area coverage in a system in accordance with an aspect of the present invention;

FIG. 6 shows an illustrative diagrammatic relative view of nadir, horizon and outer space regions for use in a system in accordance with an aspect of the present invention;

FIGS. 7A and 7B show illustrative diagrammatic elevational and plan views of an antenna system providing uniform coverage (including nadir) using multiple patch antennas;

FIG. 8 shows an illustrative graphical representation of coverage, in azimuth and elevation coordinates, provided by antenna systems of FIGS. 7A and 7B;

FIG. 9 shows an illustrative diagrammatic view of puzzle-piece antenna coverage provided by multiple antenna systems of FIGS. 7A and 7B;

FIG. 10 shows an illustrative diagrammatic view of a candidate GAUSS antenna for use in a system in accordance with an aspect of the present invention;

FIG. 11 shows an illustrative diagrammatic view of a satellite with an antenna of FIG. 10 for use in a system in accordance with an aspect of the present invention;

FIG. 12 shows an illustrative diagrammatic view of a typical un-modified antenna beam pattern using a dipole antennas in accordance with an aspect of the present invention;

FIG. 13 shows an illustrative diagrammatic view of a satellite with an antenna of FIG. 10 showing beam direction modification with phase modification to provide a beam direction toward the horizon for use in a system in accordance with an aspect of the present invention;

FIG. 14 shows an illustrative diagrammatic flowchart of a GAUSS system for use in accordance with an aspect of the present invention;

FIG. 15 shows an illustrative diagrammatic view of a plurality of antenna beams providing coverage in a puzzle-piece fashion;

FIGS. 16A and 16B show illustrative diagrammatic view of a GAUSS satellite couplet system for use in a system in accordance with an aspect of the present invention;

FIG. 17 shows an illustrative diagrammatic view of a constellation of antennas providing global coverage for use in a system in accordance with as aspect of the present invention;

FIG. 18 shows an illustrative graphical representation of a possible constellation verses antenna elevation beam-width tradeoff for use in a system in accordance with an aspect of the present invention;

FIG. 19 shows an illustrative diagrammatic view of a satellite with an antenna of FIG. 10 showing beam direction modification with two different phase modifications to provide two sets of beam directions toward the horizon for use in a system in accordance with an aspect of the present invention; and

FIG. 20 shows an illustrative graphical representation of antenna beam width versus a number of satellites needed for an associated constellation.

The drawings are shown for illustrative purposes only.

### DETAILED DESCRIPTION

In accordance with various aspects, the invention provides a global aviation unified surveillance system (GAUSS) that employs a constellation of satellites to not only provide unified traffic and weather surveillance in real-time but provide this globally and that requires no RF spectrum for aircraft and weather surveillance.

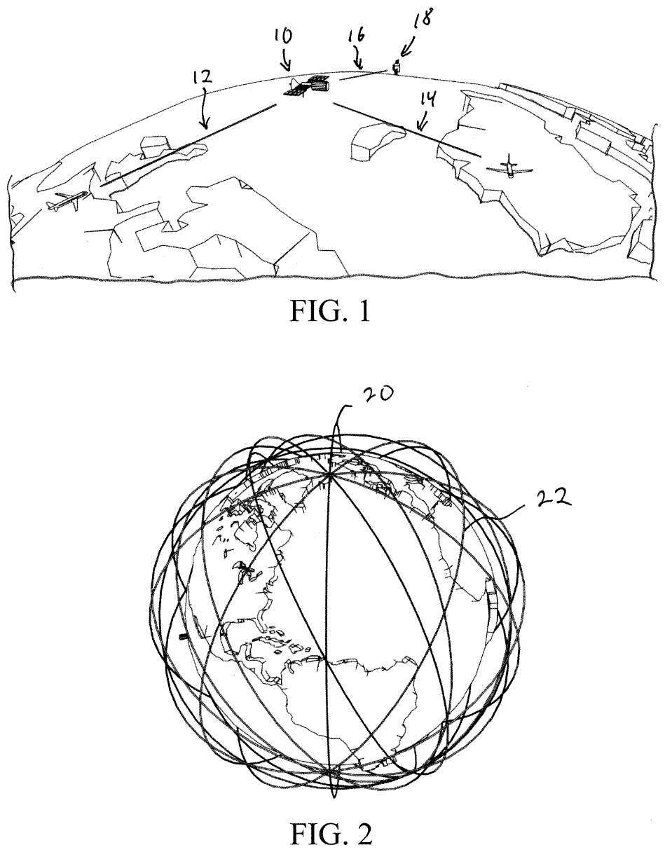

Aviation traffic and weather may be surveilled from earth orbit. For traffic, the Automatic dependent surveillance-broadcast (ADS-B), transmitted by aircraft transponders at 1090 MHz and mandated internationally, is a convenient and rich signal source. For weather, the Global Navigation Satellite Systems (GNSSs) are another convenient and rich signal source. The GNSS systems include the Global Positioning System (GPS), Glonass, Galileo, and Beidou systems, which all transmit their navigational signals in the 1-2 GHz frequency spectrum. From earth orbit, these signals may be used to measure atmospheric soundings as the GNSS satellite rises or sets, relative to the observing satellite. This process is referred to as radio occultation (RO). FIG. 1 illustrates a GAUSS satellite in the center of the image. The GAUSS satellite is making an RO sounding using the navigational signal 16 through the atmosphere from a Glonass satellite shown at 18 (Glonass 36401) as the Glonass satellite rises from the horizon. The GAUSS satellite simultaneously makes two ADS-B collections from two different aircraft ADS-B signals as shown at 12 and 14. Note that the RO sounding is made just slightly above the horizon, as a GNSS satellite rises or sets, and its navigational signal transmits the Earth's atmosphere.

ADS-B and RO signal measurement have several similarities. First, both are transmitted signals that allow a passive receiver to make important traffic and weather measurements, respectively. ADS-B provides a wealth of navigation, surveillance, and identity information. RO provides metrics such as atmospheric temperature, density, and pressure as a function of altitude. And both ADS-B and RO signal collection opportunities are primarily or exclusively near the horizon, from the perspective of an earth-orbiting satellite (as explained in the next section). And while both ADS-B and RO collection from earth orbit have been demonstrated, they both present two surveillance challenges that thus far have not been met: for meaningful and valuable surveillance, geographic variation and strong signal-to-noise (SNR) are required.

Once recognized, these several similarities (both in opportunities and challenges) suggest that a single, unified, surveillance solution can simultaneously collect and exploit these signals. The requirements are a relatively large constellation of satellites with high-gain, L-band antennae with field of view focused toward the horizon. GAUSS meets these requirements.

GAUSS monitors both (i) air traffic and (ii) weather at altitude, using a constellation of earth-orbiting satellites. FIG. 2 shows an example low earth orbit (LEO) constellation. In this case, it is a hybrid constellation, consisting of both polar orbits (e.g., as shown at 20 with an inclination angle of 90°) and inclined orbits (e.g., as shown at 22 with an inclination angle of) 50°.

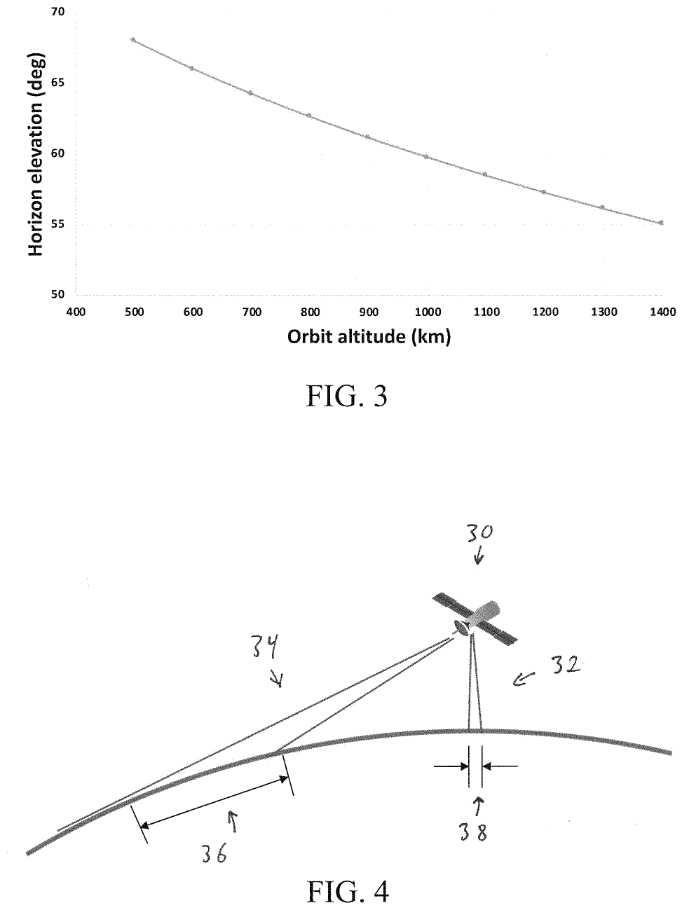

For a given satellite, the elevation angle is measured from the nadir to the horizon. Given the orbital altitude, the elevation angle at the horizon may be approximated. FIG. 3 shows the approximate horizon elevation angle as a function of the orbital altitude. As shown in FIG. 3, as the orbit altitude increases (in km), the horizon elevation (in degrees) correspondingly decreases.

The horizon elevation angle is important because this is the surveillance focus in the GAUSS concept, as illustrated in FIG. 4. FIG. 4 illustrates two antenna shown at 32, 34 beams from a satellite 30. One beam 32 is directed downward toward the nadir point (directly below the satellite), while the other beam 34 directed toward the horizon. Both beams have the same field of view (FOV) in elevation (e.g., 3 degrees or 5 degrees or 6 degrees). That is, they have the same width, in terms of the elevation angle. But as FIG. 4 shows, the beam pointed at the horizon covers a much greater area on the surface (shown at 36) of the earth than the beam pointed at the nadir (as shown at 38).

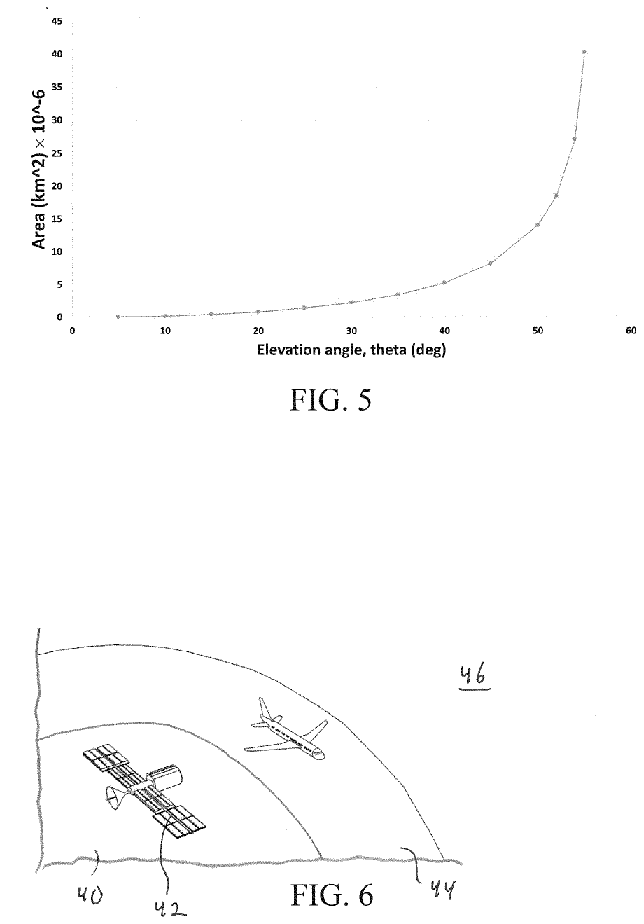

FIG. 5 shows how this surface area grows with elevation angle for a 1400 km orbital altitude, for a beam with full, 0°-360°, azimuth coverage. For example, while a beam-width of 5 degrees from 10 to 15 degrees may only cover a small area, a beam-width of 5 degrees from 50 degrees to 55 degrees may cover a very large area.

As suggested by the relationship shown in FIG. 4, FIG. 5 shows that the earth surface area surveilled grows exponentially as the maximum elevation angle of the antenna beam increases from 0° at the nadir to approximately 55° at the horizon. The relationship shown in FIG. 4 is important because the GAUSS concept requires a high-gain antenna for both the ADS-B and RO signal collections. In one way or another, depending on the particular antenna design, increasing the antenna gain requires increased size, weight and power (SWAP) for the satellite payload. The other important factor driving antenna SWAP is the FOV. As with the antenna gain, increasing the FOV, which may be accomplished with multiple antenna beams for example, in one way or another increases the satellite SWAP. Therefore, while an antenna with horizon-to-horizon, high gain coverage would satisfy the mission of ADS-B and RO surveillance, such an antenna system would be prohibitively expensive or perhaps not even feasible. This means that for a given required antenna gain, the antenna FOV is a resource with a cost that impacts the overall system design. For an efficient and feasible design, the antenna FOV resource should be used where it is most efficient. Use of the antenna FOV where it is not efficient amounts to a wasted resource. FIGS. 4 and 5 show that for the ADS-B surveillance mission, the efficiency of the FOV resource increases exponentially as it approaches the horizon, because the earth surface and nearby airspace surveilled increases exponentially. Given that the RO signals occur at the horizon, this means that surveillance resources directed toward the horizon are efficient for both the ADS-B and RO signals.

For these reasons the GAUSS concept requires an antenna with FOV primarily aimed at the horizon. In other words, there is a cone-of-silence beneath the satellite, in the nadir region. Beyond that cone-of-silence, the antenna footprint appears as a ring, extending to the horizon, with full 0°-360° azimuth coverage. FIG. 6 illustrates this antenna beam coverage pattern in a high-gain, high-search volume antenna footprint illustration as shown, compared to a low-volume nadir region as shown under the GAUSS satellite (toward the nadir).

In FIG. 6, the low-volume nadir region (shown at 40 beneath the illustrated spacecraft 42) contains relatively low-volume airspace (as indicated in FIGS. 4 and 5) whereas high-gain high volume horizon region contains relatively high-volume airspace (as shown at 44). It is here, outside the low-volume nadir region directed toward the horizon (with outer space shown at 46), that the GAUSS concept uses its high-gain, antenna beam resources.

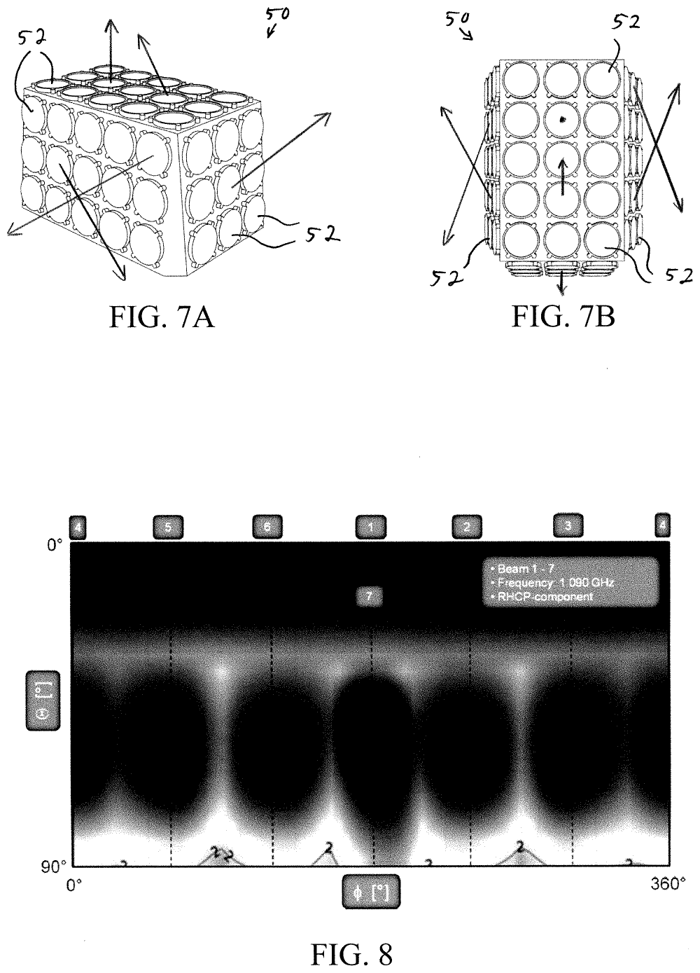

The GAUSS concept requires an antenna system with high gain of approximately 20 dB, and 0°-360° azimuth coverage, but elevation coverage toward the horizon, forming a ring coverage pattern. For comparison purposes, the Aireon payload system (provided by Aireon LLC of McLean, Va.) has seven antenna beams. Beams 1-6 are directed along equally spaced azimuth angles about the circle (φ=0°, 60°, 120°, 180°, 240°, 300°). Beam 7 is nadir-pointing (θ=0°). FIGS. 7A and 7B show a prototype schematic of the antenna payload in which the antenna 50 includes many antenna patches 52, each calibrated to provide directional reception in a different direction, providing wide coverage.

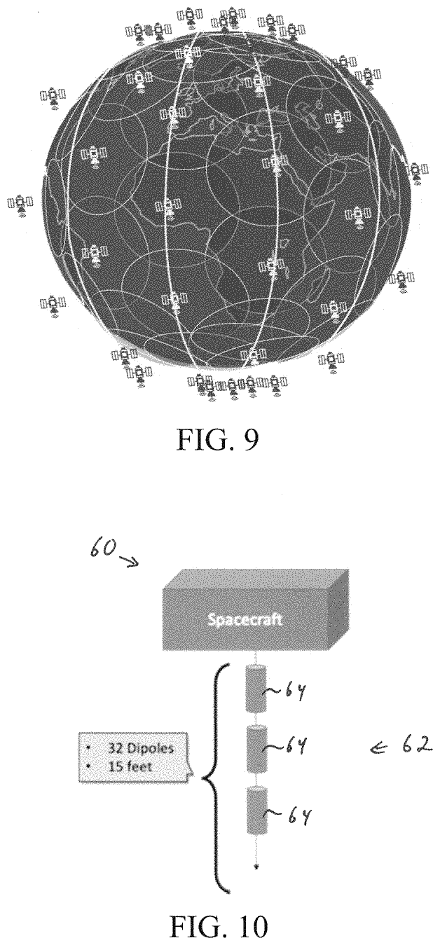

FIG. 8 shows beam footprints in elevation (y axis) vs. azimuth (x axis) for a prototype Aireon antenna employing full 0°-360° azimuth coverage. FIG. 8 shows the measured far field prototype antenna beam gains, in the elevation versus azimuth coordinates. Red corresponds to the highest gain measured and blue corresponds to the lowest gain. As FIG. 8 shows, the seven antenna beams fit together in puzzle piece fashion, to provide complete coverage, from nadir to horizon, with full 0°-360° azimuth. The Aireon payload is mounted on Iridium satellites. This constellation, nominally consisting of 66 satellites in 6 planes and 11 satellites per plane, provides complete global coverage. FIG. 9 illustrates the Iridium constellation and the Aireon payload antenna coverage, showing global puzzle piece antenna coverage. Just as the seven antenna beams fit together to give complete airspace coverage for each satellite, as shown in FIG. 8, FIG. 9 shows that the Iridium constellation with Aireon antenna payload, provides complete global coverage, again in puzzle piece fashion.

In this intuitive design, global coverage is guaranteed because the neighboring antenna beams fit together like puzzle pieces providing complete FOV coverage for each satellite, and the composite FOVs for each satellite fits together like puzzle pieces with those of neighboring satellites, providing complete FOV across the globe. But the surveillance resource is not used efficiently, and in order to provide this complete coverage, this design forfeits antenna gain. The maximum gain, corresponding to dark regions in FIG. 8, is about 10 dB. This is about 10 dB short of the required gain for useful and valuable RO and ADS-B measurements. For example, with this low gain antenna, RO measurements often are not possible at the lower (more important) altitudes below about 40,000 ft. Likewise, the ADS-B time of arrival (TOA) and frequency of arrival (FOA) measurements are not possible with the required precision for meaningful, independent, tracking accuracy.

The GAUSS concept, on the other hand, achieves the required higher gain of at least 20 dB using the reduced FOV, ring coverage pattern described above and shown in FIG. 6. To do this, the GAUSS concept uses an antenna that meets the FOV and gain requirements, while maintaining deployment and operational feasibility. This design uses distributed dipoles in a linear, phased array, as shown in FIG. 10, which shows at 60 the GAUSS novel antenna concept, consisting of distributed dipoles 64 in a linear, phased array 62. Note that the antenna boom may point toward or away from nadir.

FIG. 10 shows a candidate GAUSS antenna concept. In azimuth, this antenna provides full 0°-360° coverage. The precise number of dipoles, their dimensions and electromagnetic properties, spacing between them, and overall length of the antenna are design parameters that may be varied to achieve a particular system design and performance. For example, 32 dipoles may be used to provide a main antenna beam with 20 dB gain and approximately 3° beam-width in elevation. In this design, each dipole individually has about 6 dB gain on peak, with spacing of about six inches center-to-center, and total boom length of about 15-16 feet. The individual dipoles are identical and are approximately 5″ in length and 3″ in radius. The array of 32 dipoles can be stowed in a compact form factor and relatively easily deployed, making the GAUSS antenna concept operationally feasible.

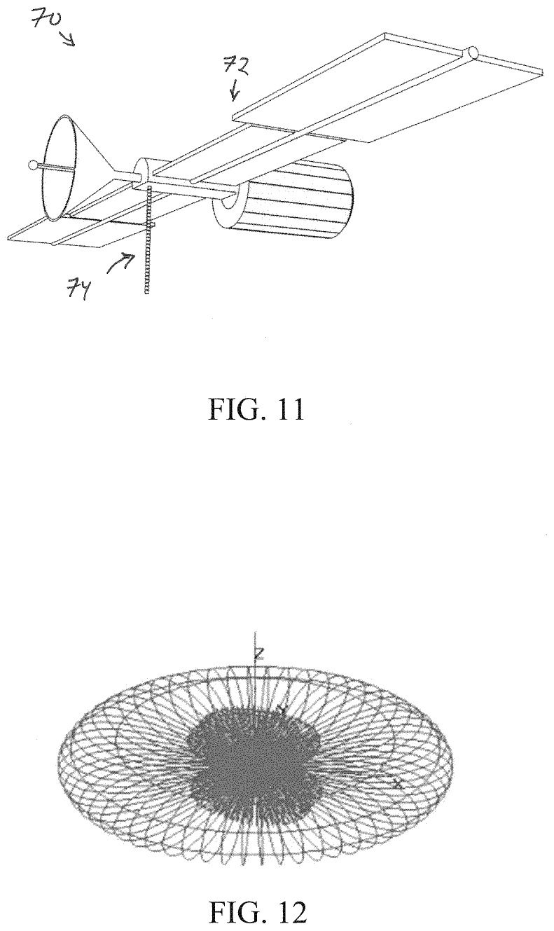

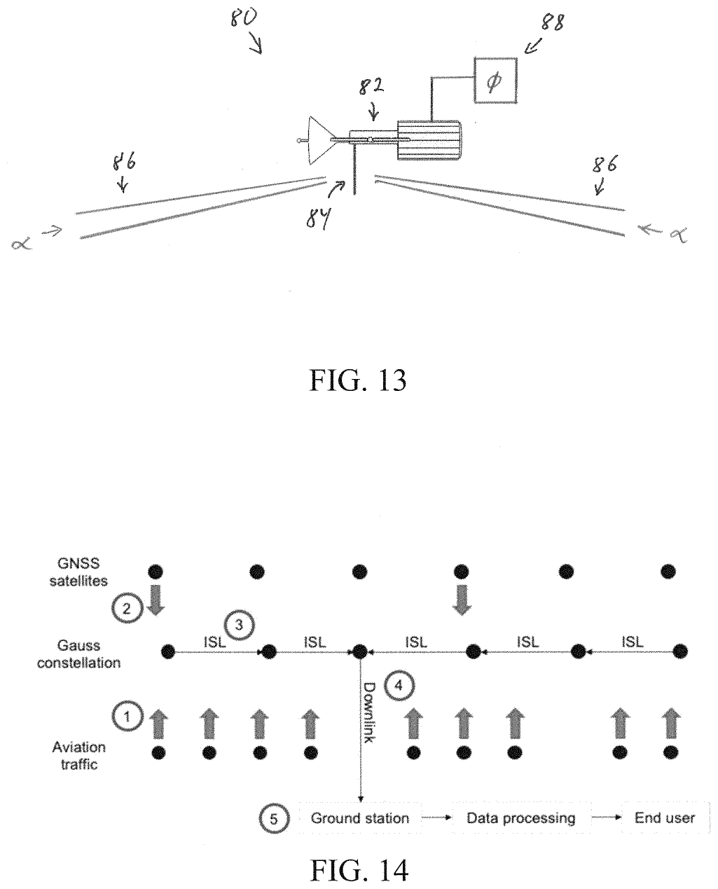

FIG. 11 shows at 70 a satellite 72 that includes an antenna system 74 of FIG. 10, including the length of plural dipoles that extend from the satellite. FIG. 12 illustrates a typical beam pattern for a non-modified dipole antenna, shown diagrammatically, although in practice it may be slightly conically shaped (non-symmetric about the x-y plane), in order to point at or below the horizon. The antenna on a GAUSS satellite may be directed along a beam direction of an angle of no more than about 60 degrees from horizontal from the satellite. In other aspects, the angle may be between about 15 and 45 degrees from horizontal, and in further aspects, the angle may be between about 25 and 35 degrees from horizontal. FIG. 13 shows diagrammatically at 80 that the system (including a satellite 82 and plural dipole antenna 84) may adjust the field to direct the field to have a beam direction (α) directed toward the horizon as discussed herein. In particular, the system may modify the phase (γ) of the received signals as shown at 88 to provide the beam direction shown at 86.

The GAUSS antenna beam can be aligned with the horizon such that the top of the beam is just above the horizon, providing RO coverage. Regarding polarization, the antenna concept is most naturally vertically polarized, which supports reception of both the ADS-B and GNSS signals. The ADS-B signal is also vertically polarized, and the GNSS signals are circularly polarized, both of which can be detected by the GAUSS vertically polarized antenna.

FIG. 14 shows an information flow chart for the GAUSS system. The five steps illustrated in FIG. 14 are as follows:
1. En route aircraft continuously transmit ADS-B out signals. The upward blue arrows indicate these ADS-B out signals are detected by the GAUSS constellation satellites. Not all aircraft are detected by all satellites, due to line-of-sight restrictions. But every aircraft is detected by one or more satellites;
2. GNSS satellites continuously transmit their navigational signals. The downward blue arrows indicate these signals are detected by the GAUSS constellation satellites. Only a few blue arrows are shown. These signals are detected only during rising or setting events in which a particular GNSS satellite is rising or setting as viewed from a particular GAUSS satellite;
3. GAUSS satellites that are not within line-of-sight of a GAUSS ground station continuously transmit their processed receiver outputs to neighboring GAUSS satellites via inter-satellite links (ISLs). These data continue to be transmitted via ISLs until they reach a GAUSS satellite that is within line-of-sight of a GAUSS ground station;
4. GAUSS satellites that are within line-of-sight of a GAUSS ground station continuously transmit processed receiver outputs (their own and those received via ISL) to a GAUSS ground station;
5. In the GAUSS ground segment, receiver data are received via downlink at ground stations including one or more computer processing systems. From there they are transmitted to the GAUSS central data processing facility, prior to analysis and distribution to end users.

In the GAUSS concept, achieving global coverage is more complicated than in the 66 Iridium constellation described above. With reference to FIG. 9, in the GAUSS concept, the GAUSS antenna beam pattern, with its cone of silence beneath the spacecraft, introduces a gap in coverage, as notionally illustrated in FIG. 13.

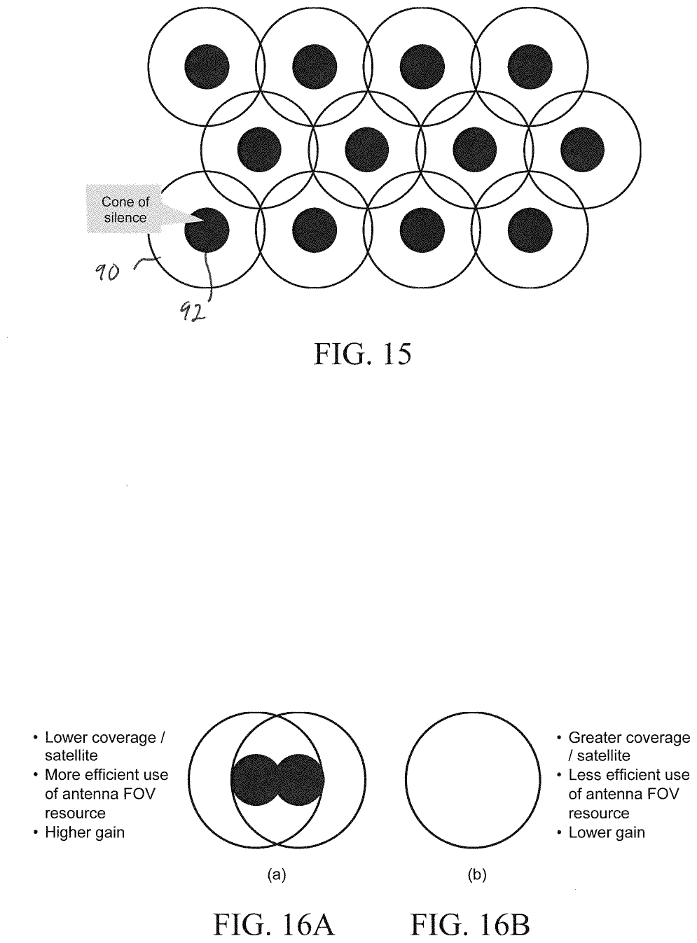

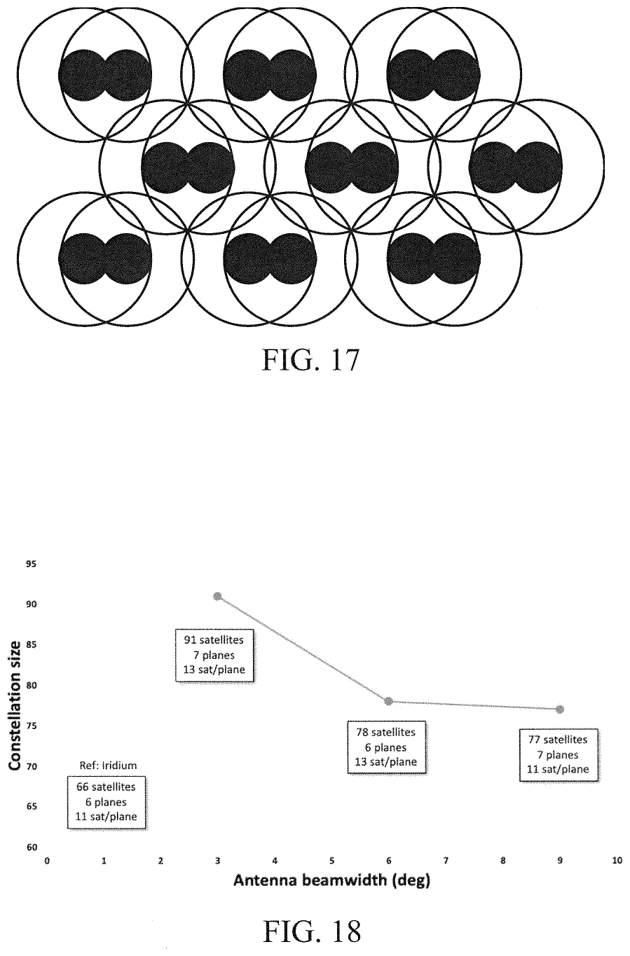

FIG. 15 illustrates 12 antenna beams providing airspace coverage in puzzle piece fashion. But in this case, the cone of silence of each beam results in 12 coverage gaps. For example, a coverage as shown at 90 may have a gap as shown at 92. These coverage gaps may be removed using a novel satellite couplet concept, where a satellite is paired with an adjacent satellite, such that the GAUSS antenna pattern of each satellite provides coverage for the other satellites cone of silence. This GAUSS satellite couplet concept is illustrated in FIG. 16A. FIG. 16B shows the simple, single satellite, case with no cone of silence, which corresponds to the Aireon design shown in FIG. 9. By comparison, the FIG. 16A GAUSS satellite couplet concept, while providing lower coverage per satellite (because of the overlap between the two adjacent antenna beams), uses its antenna beam resources more efficiently and is able to provide higher gain. Note that in the FIG. 16A GAUSS satellite couplet concept, the two satellites are placed in the same orbit, but are spaced out in the in-track direction, so one spacecraft is directly trailing the other spacecraft. This satellite couplet concept may be used in a constellation, to provide global coverage, as illustrated in FIG. 17.

To summarize, in the GAUSS concept the ring antenna beam pattern, with its cone of silence, requires additional satellites so that a satellite's ring antenna coverage helps to cover the cone of silence of its adjacent satellite. So, whereas the Iridium constellation consists of 66 satellites in 6 planes and 11 satellites per plane, the GAUSS concept, with an elevation beam width of, for example, 3°, requires a larger constellation to achieve comparable global coverage. For example, at the same Iridium altitude of 780 km and inclination of 86°, a constellation of 91 satellites in 7 planes and 13 satellites per plane may be used to provide comparable global coverage.

But the GAUSS concept allows for variations on this design. Specifically, its antenna concept shown in FIG. 10 supports the generation of multiple beams electronically. This may be accomplished using delay lines which generate phase offsets between the dipoles, and effectively create a new beam with an offset in elevation. For example, whereas the nominal antenna beam may provide elevation coverage from just above the horizon to about 3° below the horizon, an adjacent second beam may be generated providing elevation coverage from 3°-6° below the horizon. Beyond this, additional beams may be generated as well. In this way the elevation beam-width may be increased in approximately 3° increments. The cost of this generation of additional beams is additional SWAP, as additional electronics are required. The benefit is that an expanded FOV for each satellite means that fewer satellites are required for global coverage. FIG. 18 illustrates a possible Constellation vs antenna elevation beam-width tradeoff.

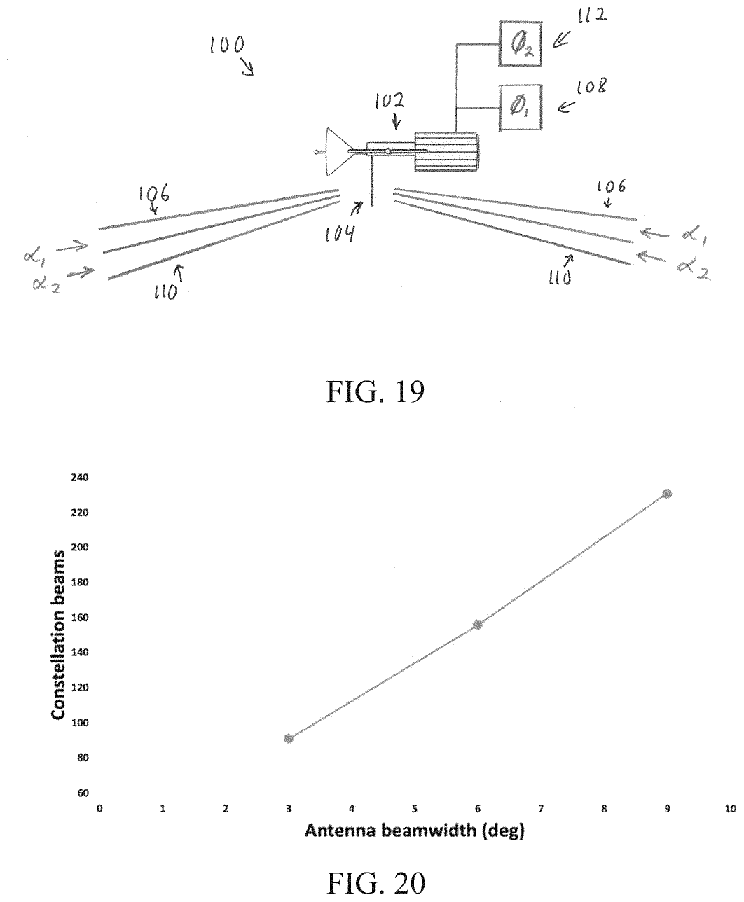

FIG. 19 shows diagrammatically at 100 that the system may provide two phase modifications (φ₁, φ₂) to the field to direct the field to have two sets of beam directions (α₁, α₂) directed toward the horizon as discussed herein. In particular, the system 100 includes a satellite 102 with a plural dipoles antenna 104. The system may provide a first modification of the phase (φ₁) of the received signals as shown at 108 to provide the beam direction (α₁) shown at 106, and may also provide a second modification of the phase (φ₂) of the received signals as shown at 108 to provide the beam direction (α₂) shown at 108. The two sets of beam directions may, for example, be 4-8 degrees from horizontal, and 8 to 15 degrees from horizontal. Since each beam requires additional SWAP, it is meaningful to consider not merely the constellation size, but also the total number of beams in the constellation. FIG. 20 illustrates this tradeoff, showing the number of beams in the constellation vs antenna elevation beam-width tradeoff. FIG. 20 shows that whereas an increasing beam-width results in fewer satellites required in the constellation, as shown in FIG. 18, it nonetheless results in an increased total number of beams in the constellation. Thus, a tradeoff must be calculated between the number of satellites and the number of beams. Fewer satellites can be achieved by increasing the beam-width, but each satellite becomes more costly. If the number of beams dominates the cost calculation, then the tradeoff clearly favors the minimum, 3° beam-width. This reflects the fact that the surveillance resource efficiency is maximized at the horizon, as discussed above. As the beam-width is increased, deviating farther from the horizon, the resource efficiency is reduced. Another key factor in the tradeoff calculation is that a larger constellation favors the RO mission, because the number of RO observations scales linearly with the number of satellites in the constellation.

In accordance with various embodiments therefore, the invention provides a single system, including a satellite constellation (space segment) and ground stations and data processing (ground segment) that may be used to perform global, real-time, unified traffic and weather surveillance. A single system is also provided that including a satellite constellation (space segment) and ground stations and data processing (ground segment) may be used to collect simultaneously ADS-B signals from aircraft and radio occultation signals from Global Navigation Satellite Systems, which are both in the L-band of radio frequencies. The satellite antenna provides simultaneous wide field of view and high gain by focusing on the horizon area of its earth coverage. A satellite antenna is also provided that provides simultaneous high gain collection of ADS-B and RO signals by focusing on the horizon area of its earth coverage.

Satellite antennas of various aspects of the invention are provided for use with much higher efficiency if its field of view is restricted to the horizon area of its earth coverage. Further, such antennas are provided for use with much higher efficiency if its field of view forms a ring, with 0-360 degree azimuth coverage, and a relatively thin coverage, of approximately 3 degrees, in elevation coverage. A surveillance system is therefore provided that includes a space segment and a ground segment, that is optimized for a particular mission, by using a GAUSS antenna pattern, and trading off (i) the ring (or elevation angle) width which influences the satellite size, weight and power, versus (ii) the number of satellites in the constellation. A surveillance system is also provided that includes a space segment and a ground segment, that is optimized for a particular mission, by using a GAUSS antenna pattern, and trading off (i) the ring (or elevation angle) width which influences the satellite size, weight and power, versus (ii) the number of satellites in the constellation. Further, Satellites with GAUSS antenna patterns provides gapless surveillance coverage, within their respective field of views of the earth, by using a satellite couplet concept, wherein the spacecraft are placed in the same orbit, and spaced slightly apart, in the in-track direction, such that the antenna beam footprint of each spacecraft covers the cone of silence of the other spacecraft. A constellation of satellites with GAUSS antenna patterns may therefore achieve seamless and complete global coverage using the satellite couplets.

Those skilled in the art will appreciate that numerous modifications and variations may be made to the above disclosed embodiments without departing from the spirit and scope of the present invention.

What is claimed is:

1. A global airspace surveillance system comprising a plurality of satellites that derive weather information from GNSS satellites, and that receive air traffic information from air traffic via satellite antennas directed toward earth's horizon.

2. The global airspace surveillance system as claimed in claim 1, wherein the air traffic information includes ADS-B signals.

3. The global airspace surveillance system as claimed in claim 2, wherein each of the plurality of satellites includes an antenna that is directed toward an earth horizon.

4. The global airspace surveillance system as claimed in claim 3, wherein each of the plurality of satellites includes an antenna that is not directed in a nadir direction.

5. The global airspace surveillance system as claimed in claim 4, wherein each of the plurality of satellites includes a series dipole antenna.

6. The global airspace surveillance system as claimed in claim 3, wherein the antenna that is directed toward an earth horizon is directed along an angle range of no more than about 60 degrees from horizontal at each respective satellite.

7. A method of providing a global airspace surveillance system, said method comprising providing a plurality of satellites, deriving weather information from GNSS satellites, and receiving air traffic information from air traffic via satellite antennas directed toward earth's horizon.

8. The method as claimed in claim 7, wherein the air traffic information includes ADS-B signals.

9. The method as claimed in claim 8, wherein each of the plurality of satellites includes an antenna that is directed toward an earth horizon.

10. The method as claimed in claim 9, wherein each of the plurality of satellites includes an antenna that is not directed in a nadir direction.

11. The method as claimed in claim 9, wherein each of the plurality of satellites includes a series dipole antenna.

12. The method as claimed in claim 9, wherein the antenna that is directed toward an earth horizon is directed along an angle range of no more than about 60 degrees from horizontal at each respective satellite.

13. A global airspace surveillance system comprising a plurality of satellites that each include at least one antenna that is directed along a beam direction of earth's horizon at an angle of no more than about 60 degrees from horizontal at each respective satellite.

14. The global airspace surveillance system as claimed in claim 13, wherein each of the plurality of satellites includes an antenna that is not directed in a nadir direction.

15. The global airspace surveillance system as claimed in claim 14, wherein each of the plurality of satellites includes a series dipole antenna.

16. The global airspace surveillance system as claimed in claim 14, wherein each of the plurality of satellites derives weather information from GNSS satellites, and receives air traffic information from air traffic.

17. The global airspace surveillance system as claimed in claim 16, wherein the air traffic information includes ADS-B signals.

18. The global airspace surveillance system as claimed in claim 13, wherein the system provides a single system, including a satellite constellation (space segment) and ground stations and data processing (ground segment) that may be used to perform global, real-time, unified traffic and weather surveillance.

19. The global airspace surveillance system as claimed in claim 13, wherein the system includes a satellite constellation (space segment) and ground stations and data processing (ground segment) may be used to collect simultaneously ADS-B signals from aircraft and radio occultation signals from Global Navigation Satellite Systems, which are both in the L-band of radio frequencies.

20. The global airspace surveillance system as claimed in claim 13, wherein the system provides gapless surveillance coverage, within their respective field of views of the earth, by using a satellite couplet concept, wherein the spacecraft are placed in the same orbit, and spaced slightly apart, in the in-track direction, such that the antenna beam footprint of each spacecraft covers the cone of silence of the other spacecraft.
